(19) United States
(12) Patent Application Publication
(10) Pub. No.: US 2017/0070567 A1
(43) Pub. Date: Mar. 9, 2017

(54) LOAD BALANCING APPARATUS AND LOAD BALANCING METHOD

(71) Applicant: Electronics and Telecommunications Research Institute, Daejeon (KR)

(72) Inventor: Byung Gyu LEE, Sejong-Si (KR)

(21) Appl. No.: 15/220,954

(22) Filed: Jul. 27, 2016

(30) Foreign Application Priority Data
Sep. 7, 2015 (KR) 10-2015-0126376

(51) Int. Cl. H04L 29/08

(52) U.S. Cl. CPC H04L 67/1008; H04L 67/101; H04L 67/327; H04L 67/1023

(57) ABSTRACT

A load balancing apparatus includes a server cluster including at least one server, a profile management unit, and a service scheduling unit. The profile management unit manages a profile of loads required to provide a service and a profile of the server included in the server cluster on the basis of a request from a client. The service scheduling unit receives the profile of the loads and the profile of the server, provided from the profile management unit, to determine a server to process the loads. The profile of the server includes energy-performance information of a corresponding server.

### CROSS-REFERENCE TO RELATED APPLICATION

This application claims priority to and the benefit of Korean Patent Application No. 10-2015-0126376, filed on Sep. 7, 2015, in the Korean

Intellectual Property Office, the entire contents of which are incorporated herein by reference in their entirety.

### BACKGROUND

1. Field

An aspect of the present disclosure relates to load balancing, and more particularly, to a load balancing apparatus and a load balancing method, which can assign a load to a server cluster including a plurality of servers.

2. Description of the Related Art

With the development of communication networks such as Internet, many services are created through the Internet. Services gradually increase in the form in which a client performs an operation or stores data in a server host through a network. Due to the increase in the services, it is required to develop a load balancing technique for preventing service requests from being concentrated on a specific node, i.e., a specific server. According to the existing load balancing apparatuses and load balancing methods, requests of clients are sequentially assigned to a plurality of nodes or are assigned to nodes selected at random. In addition, weighted values are applied to nodes having different performances, so that requests of clients are assigned to the nodes according to the weighted values or so that it is determined whether requests of clients are to be assigned to the nodes, based on current available capacities of the nodes. The existing load balancing apparatuses and load balancing methods focus on solving the problem that a load is concentrated on one server.

As the performance of servers is improved, and service demand considerably increases, the power consumption of a data center in which clusters for providing various services are gathered rapidly increases. Accordingly, the power consumption occupies a large portion of cost for managing the data center, and the cost for managing the data center remarkably increases. For this reason, load balancing methods capable of not only solving the problem that a load is concentrated on one server but also saving energy through load balancing have appeared.

In the existing load balancing apparatuses and load balancing methods, the performance and power consumption of each server configured as a cluster are not considered together. In the case of servers configured with the same hardware, cooling devices, e.g., cooling fans, etc. are operated differently from each other depending on positions of the servers, and therefore, power consumptions of the servers may be different from each other. Also, the power consumption of each server may be changed due to breakdown of the hardware depending on a usual load performance state of the server.

When a load is assigned by considering only the performance of each server without considering the energy consumption of each server, energy cannot be efficiently consumed, and therefore, the servers cannot be efficiently used. When a load is assigned by only the power consumption of each server without considering the performance of each server, a service requiring high performance is assigned to a low-performance server, which does not satisfy a response speed requested by a client.

### SUMMARY

Embodiments provide a load balancing apparatus and a load balancing method, in which a load profile is created through analysis for a service request from a client, a profile of energy-performance information and idle energy-performance information of each server is created, and a server suitable for the service request is assigned through service scheduling, based on the created profiles, so that it is possible to improve the energy efficiency of a cluster and to maintain service quality.

According to an aspect of the present disclosure, there is provided a load balancing apparatus including: a sever cluster configured to include at least one server; a profile management unit configured to manage a profile of loads required to provide a service and a profile of the server included in the server cluster on the basis of a request from a client; and a service scheduling unit configured to receive the profile of the loads and the profile of the server, provided from the profile management unit, to determine a server to process the loads, wherein the profile of the server includes energy-performance information of a corresponding server.

The profile management unit may include: a load profile management unit configured to register, update, and delete the profile of the loads required to provide the service; a server profile management unit configured to register, update, and delete the profile of the server included in the server cluster; a server monitoring unit configured to monitor an operational state of the server included in the server cluster; and a storage unit configured to store data received from the load profile management unit, the server profile management unit, and the server monitoring unit.

The data stored in the storage unit may include the profile of the loads, the profile of the server, and a result obtained by monitoring the operational state of the server. The load profile management unit may register, update, and delete the profile of the loads, stored in the storage unit. The server profile management unit may register, update, and delete the profile of the server, stored in the storage unit. The server monitoring unit may monitor the operational state of the server and stores and updates the monitored result in the storage unit.

The service scheduling unit may include: a service provisioning unit configured to receive the result obtained by monitoring the operation state of the server, provided from the profile management unit, to create a server list on the basis of a resource available capacity of each server; a server selection unit configured to assign a server to perform each load on the basis of the profile of the loads, provided from the profile management unit, and the server list provided from the service provisioning unit; and a job queue configured to arbitrarily store information on the server assigned for each load by the server selection unit.

The sever list may be created as a hash table according to a resource utilization of each server.

The hash table may use a server ID as a key value, and buckets may be aligned based on energy-performance information of each server.

The server selection unit may select a server having the highest energy-performance value, based on the energy-performance information of each server in the hash table.

The profile of the server may include idle energy-performance information of a corresponding server. When a profile of a corresponding load does not exist in the storage unit of the profile management unit, the server selection unit may select a server having the highest idle energy-performance value among servers in an idle state. The load profile management unit may create the profile of the load and stores the profile of the load in the storage unit.

According to an aspect of the present disclosure, there is provided a load balancing apparatus for assigning a load to a server cluster including a plurality of servers, the load balancing apparatus including: a profile management unit configured to manage load profile information required to provide a service and server profile information of the servers included in the server cluster on the basis of a request from a client, wherein the server profile information includes energy-performance information and idle energy-performance information of a corresponding server; and a service scheduling unit configured to receive the load profile information and the server profile information, provided from the profile management unit, to determine a server to process the loads.

The profile management unit may include: a storage unit configured to store the load profile information and the server profile information; a load profile management unit configured to manage the load profile information stored in the storage unit; a server profile management unit configured to manage the server profile information stored in the storage unit; and a server monitoring unit configured to monitor operational states of the servers included in the server cluster.

The service scheduling unit may include: a service provisioning unit configured to receive a monitoring result of the server monitoring unit and create a server list on the basis of resource available capacities of the servers; a server selection unit configured to specify a server to perform a corresponding load on the basis of the server list and the load profile information; and a job queue configured to store a selection result of the server selection unit.

According to an aspect of the present disclosure, there is provided a load balancing method for assigning a load to a server cluster including a plurality of servers, the load balancing method including: receiving a service request from a client; searching a load profile on the basis of the service request; when the load profile is searched, performing service provisioning on the basis of the searched load profile, wherein the performing of the service provisioning includes creating a server list on the basis of operational states and resource utilizations of the plurality of servers included in the server cluster; scheduling a corresponding load to a server having the highest energy-performance value on the basis of a result obtained by performing the service provisioning; assigning an operation schedule to a job queue on the basis of a scheduling result; and assigning, to the selected server, a load of the operation schedule assigned to the job queue.

The load balancing method may further include, after the assigning of the load to the selected server, updating the load profile.

The load balancing method includes, when the load profile is not searched in the searching the load profile on the basis of the service request, searching servers in an idle state among the plurality of servers included in the server cluster, assigning the load to a server having the highest idle energy-performance value among the searched servers, and creating and storing a load profile of the load.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a general load balancing technique.

FIG. 2 is a block diagram illustrating a load balancing apparatus according to an embodiment of the present disclosure.

FIG. 3 is a block diagram illustrating a load balancing apparatus according to an embodiment of the present disclosure.

FIG. 4 is a block diagram illustrating an example of a profile management unit included in a load balancing apparatus according to an embodiment of the present disclosure.

FIG. 5 is a block diagram illustrating an example of a service scheduling unit included in a load balancing apparatus according to an embodiment of the present disclosure.

FIG. 6 is a flowchart illustrating a load balancing method according to an embodiment of the present disclosure.

FIG. 7 is a graph illustrating power consumptions required to perform a specific load in two exemplary servers according to their resource utilizations.

FIG. 8 is a graph illustrating numbers of transactions performed per unit time in two exemplary servers according to their resource utilizations.

FIG. 9 is a graph illustrating energy-performance information in two exemplary servers according to their resource utilizations.

### DETAILED DESCRIPTION

Hereinafter, preferred embodiments of the present disclosure will be described in detail with reference to the accompanying drawings. However, the present disclosure is not limited to the embodiments but may be implemented into different forms. These embodiments are provided only for illustrative purposes and for full understanding of the scope of the present disclosure by those skilled in the art. Throughout the drawings, like elements are designated by like reference numerals.

According to a load balancing apparatus and a load balancing method of the present disclosure, in an environment of a server cluster including a plurality of servers to provide a service to a client, a load is dynamically is assigned by simultaneously considering load characteristics of the service requested by the client and energy performance characteristics of the servers. Accordingly, in terms of energy and performance, a load is efficiently assigned to an individual server in the server cluster, so that it is possible to save power required to operate the server cluster and to maintain the response speed of the service requested by the client.

FIG. 1 is a diagram illustrating a general load balancing technique.

Referring to FIG. 1, a plurality of clients 101, 103, and 105 are connected to a network 110, and a server cluster 130 is also connected to the network 110. The server cluster 130 may include a plurality of servers 131, 132, 133, . . . , 137). Each of the clients 101, 103, and 105 may request the server cluster 130 of a service through the network 110. Each of the clients 101, 103, and 105 may be a mobile device such as a smart phone, a tablet computer, or a notebook computer, or may be a device connected by wire to the network 110. Each of the clients 101, 103, and 105 requests the server cluster 130 of a service through the network 110. The server cluster 130 assigns a load for performing the service to one of the servers 131, 132, 133, . . . , 137 in the server cluster 130. The server cluster 130 may be configured with a plurality of nodes having a single hardware specification or a plurality of nodes having various hardware specifications. According to the existing load balancing techniques, a load for performing a service request received from each of the clients 101, 103, and 105 is randomly assigned to the servers 131, 132, 133, . . . , 137 in the server cluster 130, assigned based on a node available capacity, or assigned by applying a weighted value to node performance in the case of nodes having different hardware specifications. When a load is assigned by considering only the performance of each server in the server cluster without considering the energy consumption of each server, energy cannot be efficiently consumed, and therefore, the servers cannot be efficiently used. When a load is assigned by only the power consumption of each server without considering the performance of each server, a service requiring high performance is assigned to a low-performance server, which does not satisfy a response speed requested by a client.

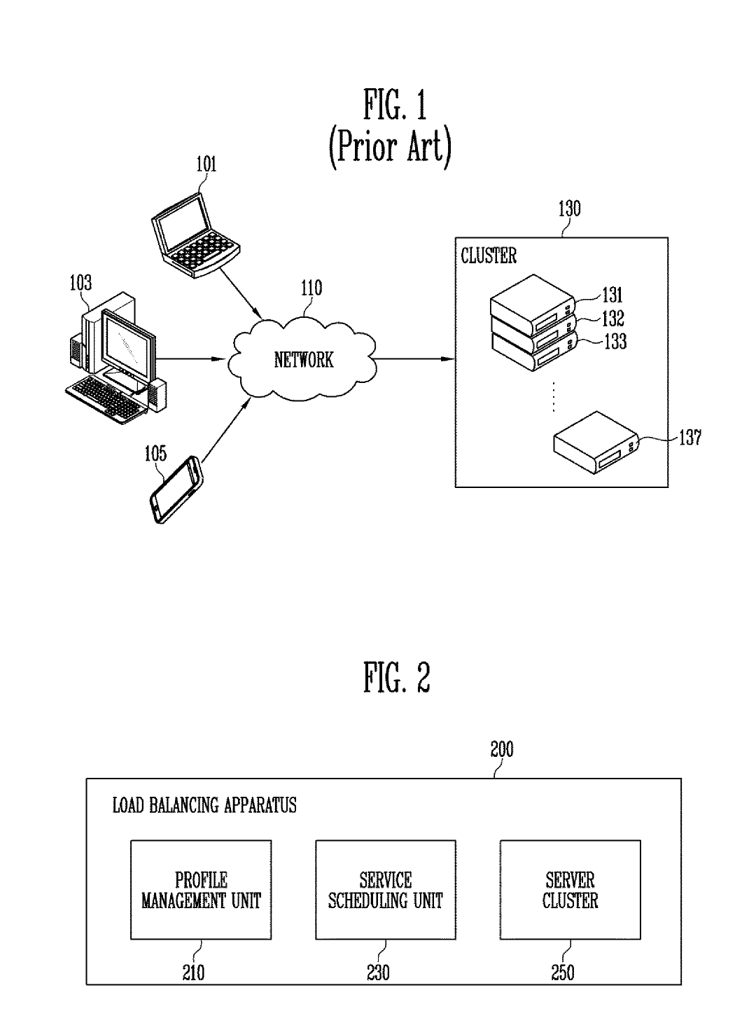

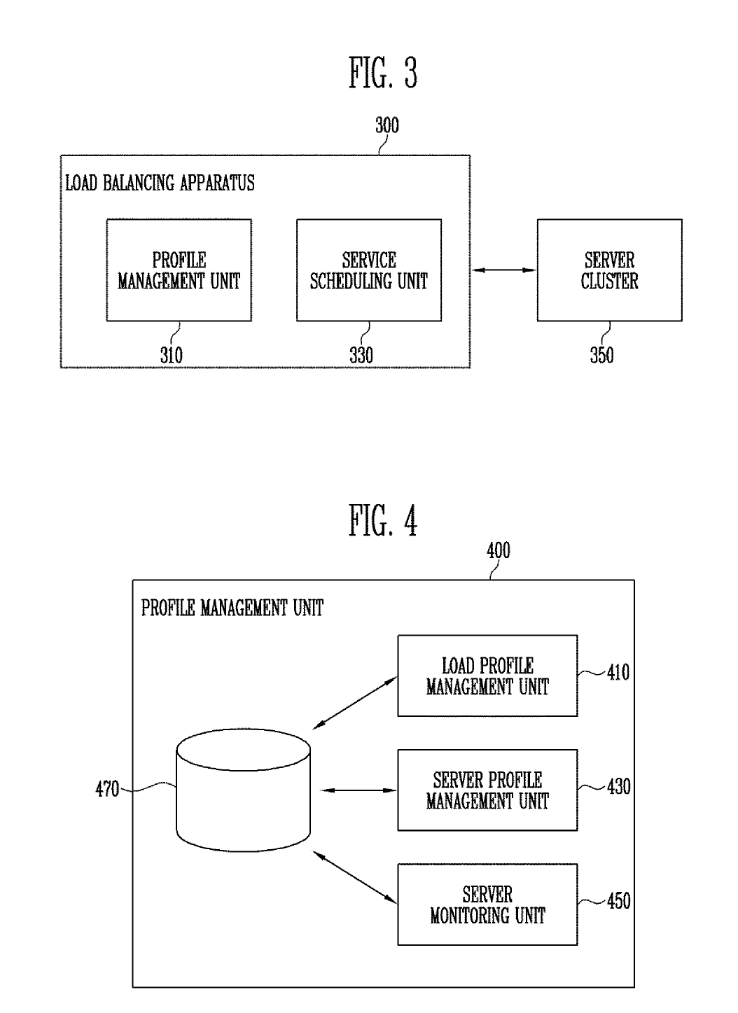

FIG. 2 is a block diagram illustrating a load balancing apparatus according to an embodiment of the present disclosure.

Referring to FIG. 2, the load balancing apparatus according to the embodiment of the present disclosure includes a profile management unit 210, a service scheduling unit 230, and a server cluster 250. The server cluster 250 includes at least one server.

The profile management unit 210 manages, based on a service requested from a client, a profile of loads required to provide the corresponding service and a profile of a server included in the server cluster 250. The profile of the loads may be profile information on loads required to provide the service requested from the client. The profile of the loads may be referred to as load profile information. The load profile information may include information on a system resource required to process the corresponding load. Also, the load profile information may include information on a time required when a load is processed by a specific resource. Meanwhile, the profile of the server may be detailed information of each server included in the server cluster 250. The profile of the server may be referred to as server profile information.

In an embodiment, the profile of the server may include energy-performance information of a corresponding server. A power consumption of each server may be measured by a sensor equipped in the server or a counter provided in hardware. In another embodiment, the power consumption of each server may be measured by a measuring instrument at the outside of the server. The power consumption may be input as power use information. In an exemplary embodiment, the “energy-performance information” may be defined as information obtained by digitizing server performance versus power consumption in a resource utilization section of a corresponding server. For example, the server performance versus power consumption when the resource utilization of a corresponding server is 10% may be different from that when the resource utilization of the corresponding server is 90%.

In an embodiment, the energy-performance information may be the amount of energy consumed based on a processing speed of a specific load. In another embodiment, the energy-performance information may be a value obtained by dividing power into a number of times when a specific load having a short performance time is performed per unit time. Here, the specific load that becomes a reference herein may have the same characteristic as loads mainly performed in the sever cluster, and may be varied depending on kinds of loads performed in the server cluster.

In an embodiment, the energy-performance information may be created in the following manner. A specific load is assumed as a transaction for a web service, and a number of transactions per unit time and the amount of power consumption of a system may be measured depending on a resource utilization (a CPU, a memory, etc.) of a server from an idle state of the cluster.

For example, numbers of transactions per unit time may be measured in each of cases where resource utilizations are 10%, 20%, . . . , 90%, 100%, respectively. It is assumed that information on a power consumption P is collected using a power measuring sensor installed in the server. In this case, energy-performance information at each resource utilization may be calculated as shown in the following Equation 1.

EP_{RU}=OP_{RU}/P_{RU} (1)

In Equation 1, EP_{RU} may be energy-performance information at a corresponding resource utilization RU. Also, OP_{R} may be a number of transactions per unit time. Meanwhile, P_{RU} may be a power consumption per unit time, which is used for the transactions.

For example, when the resource utilization is 20%, the energy-performance information EP_{RU} may be calculated as shown in the following Equation 2.

EP₂₀=OP₂₀/P₂₀ (2)

The load balancing apparatus 200 according to the embodiment of the present disclosure creates server performance versus power consumption corresponding to the entire utilization section of each of the servers included in the server cluster 250, i.e., the section from 0% to 100% as energy-performance information of the corresponding server, and allows the profile management unit 210 to manage the energy-performance information as server profile information.

In an embodiment, the amount of energy consumed by a server based on a processing speed of a specific load that becomes a reference may be defined as energy-performance information. In another embodiment, in the case of a specific load having a short performance time, a value obtained by dividing power into a number of times when the specific load is performed per unit time may be defined as the energy-performance information. In the load balancing apparatus 200 according to the embodiment of the present disclosure, performance of processing a load versus power consumption is included as the energy-performance information in the server profile information, a server to which the load is to be assigned is selected based on the energy-performance information. Thus, a server suitable for a service requested by a client is assigned, so that it is possible to save power consumption of the server cluster 250 and to improve/maintain the quality of the service provided to the client.

The energy-performance information may be created when a server in the server cluster 250 is initially installed and operated. In an embodiment, the energy-performance information included in the server profile information may be updated when there occurs an event having influence on the energy consumption or performance of the server, such as when the physical position of the corresponding server is changed or when the interior of the server or hardware (including a cooling device) related to the server is changed. According to an embodiment, an energy-performance value included in the server profile information may be periodically updated according to a predetermined period. Newly created server profile information is stored and updated in a storage unit of the profile management unit 210.

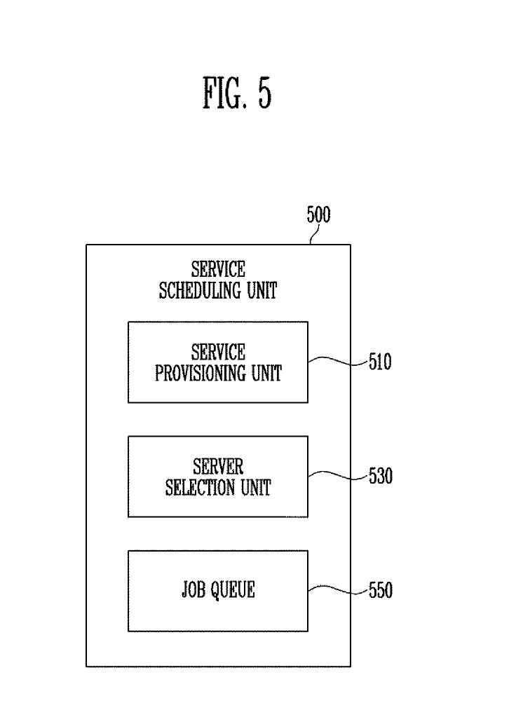

Meanwhile, the profile management unit 210 may monitor the servers in the server cluster 250. A detailed example of the profile management unit 210 will be described later with reference to FIG. 4.

The service scheduling unit 230 receives the profile of the loads and the profile of the server, provided from the profile management unit 210, to determine a server to process the loads. Here, the profile of the server includes energy-performance information of a corresponding server. In other words, the service scheduling unit 230 schedules in which server of the server cluster 250 loads required to provide a service are to be performed through service provisioning in a server having excellent energy efficiency, based on the load profile information and the server profile information, provided from the profile management unit 210. That is, the service scheduling unit 230 receives the profile of loads and the profile of the server, and selects a server having the highest server performance versus power consumption for performing a corresponding load on the basis of the energy-performance information included in the profile of the server, thereby assigning the corresponding load to the selected server. Thus, a load can be dynamically assigned to servers by simultaneously considering energy and performance characteristics of the servers that perform the load.

The server cluster 250 is configured with at least one server that performs loads required to provide a service requested from a client. The servers may be configured with servers having the same hardware specification or various kinds of servers having different hardware specifications. The servers in the server cluster 250 may be managed by being divided into a plurality of groups or zones.

FIG. 3 is a block diagram illustrating a load balancing apparatus according to an embodiment of the present disclosure.

Referring to FIG. 3, the load balancing apparatus 300 according to the embodiment of the present disclosure, which assigns a load to a server cluster 350 including a plurality of servers, includes a profile management unit 310 and a service scheduling unit 330. The profile management unit 310 manages, based on a service requested from a client, load profile information required to provide the service and server profile information of servers included in the server cluster 350. The service scheduling unit 330 receives the load profile information and the server profile information, provided from the profile management unit 310, to determine a server to process loads.

The load balancing apparatus 300 of FIG. 3 is configured similarly to the load balancing apparatus 200 of FIG. 2. However, the load balancing apparatus 300 of FIG. 3 does not include the server cluster 350. That is, while the load balancing apparatus 200 of FIG. 2 includes the server cluster 250, the load balancing apparatus 300 of FIG. 3 assigns a load to the servers in the server cluster 350 in a state in which it is located outside the server cluster 350. Configurations and operations of the profile management unit 310 and the service scheduling unit 330, which are included in the load balancing apparatus 300 of FIG. 3, may be identical or similar to those of the profile management unit 210 and the service scheduling unit 230 of FIG. 2. Therefore, descriptions of detailed operations of the profile management unit 310 and the service scheduling unit 330, which are included in the load balancing apparatus 300 of FIG. 3, will be omitted.

FIG. 4 is a block diagram illustrating an example of a profile management unit included in a load balancing apparatus according to an embodiment of the present disclosure.

Referring to FIG. 4, the profile management unit 400 includes a load profile management unit 410 for registering, updating, and deleting a profile of loads required to provide a service, a server profile management unit 430 for registering, updating, and deleting a profile of a server included in a server cluster, a server monitoring unit 450 for monitoring an operational state of the server included in the server cluster, and a storage unit 470 for storing data received from the load profile management unit 410, the server profile management unit 430, and the server monitoring unit 450.

In an embodiment, data stored in the storage unit 470 includes a result obtained by monitoring the profile of the loads, the profile of the server, and the operational state of the server. Accordingly, the load profile management unit 410 registers, updates, and deletes the profile of the loads, stored in the storage unit 470, and the server profile management unit 430 registers, updates, and deletes the profile of the server, stored in the storage unit 470. The server monitoring unit 450 monitors the operational state of the server in the server cluster, and stores and updates the monitored result in the storage unit 470.

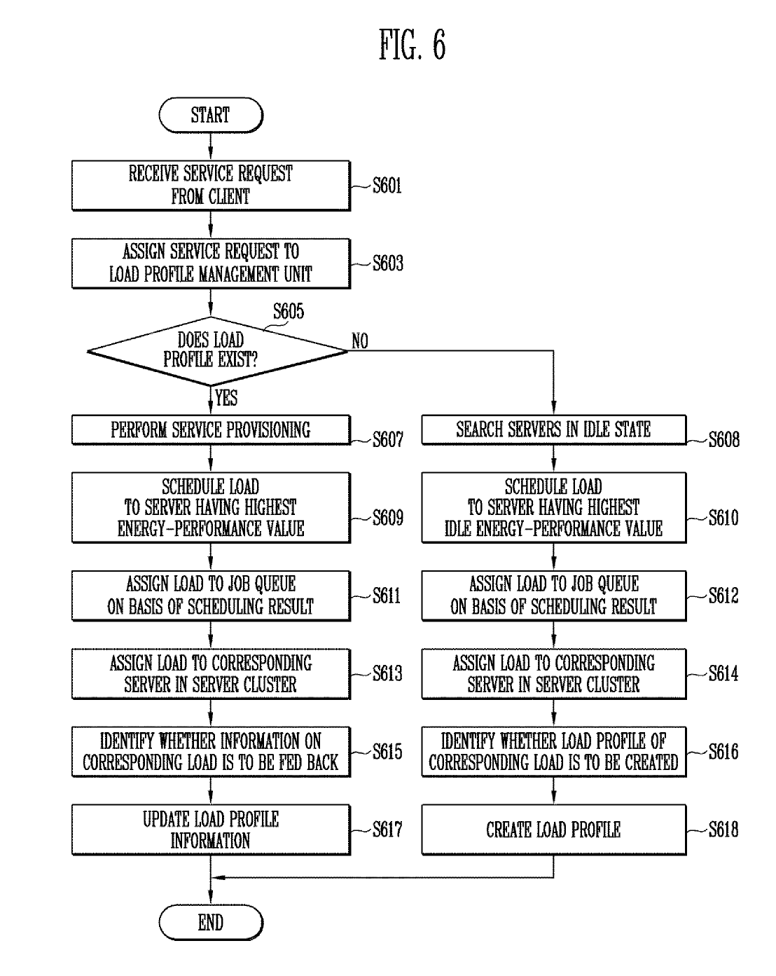

The load profile management unit 410 analyzes a service requested from a client and manages a profile of loads required to perform the corresponding service. The profile of the loads, i.e., load profile information may include information on a time required when a corresponding load is performed, an average resource utilization of a server, required when the corresponding load is performed, a list of services requiring the corresponding load, etc. If a service is requested from a client, the load profile management unit 410 searches for the storage unit 470 to determine whether there exists a profile of a load required to perform the corresponding service. When the profile of the corresponding load exists, the load profile management unit 410 transmits the searched profile of the load to a service scheduling unit such that the profile of the load is used to select to perform the load. When the profile of the corresponding load does not exist, the load profile management unit 410 may transmit, to the service scheduling unit, a message that the profile of the load does not exist. The service scheduling unit may assigns the load to a server on the basis of the message that there exists no searched load profile information or load profile information. An operation of the service scheduling unit will be described later with reference to FIG. 5.

Meanwhile, when the profile of the corresponding load does not exist, the load profile management unit 410 may determine whether the profile of the load is to be created after transmitting the message that the profile of the load does not exist. The creation of the load profile information may be determined by an input from a manager. In order to create new load profile information, the load profile management unit 410 may receive load processing information of a specified server, which is transmitted from the server monitoring unit 450. That is, if a server to process the corresponding load is specified by the service scheduling unit, the server monitoring unit 450 monitors an actual load processing situation of the determined server and transmits the monitored result to the load profile management unit 410. The load profile management unit 410 may create a profile of the corresponding load on the basis of a result obtained by monitoring the load processing situation and store the created profile in the storage unit 470.

The server profile management unit 430 manages a profile of servers in the server cluster. In an embodiment, the server profile information may include energy-performance information of a corresponding server. As described above, the energy-performance information may be information on a relationship between power consumed when each server in the server cluster processes a specific load and processing performance of the corresponding load. The energy-performance information is included in the server profile information. The server profile management unit 430 creates the server profile information and store the created server profile information in the storage unit 470. The server profile management unit 430 may update the energy-performance information in the server profile information stored in the storage unit 470 when there occurs an event having influence on an energy value of the server, a performance value of the server, or the like. In another embodiment, the server profile management unit 430 may periodically update the energy-performance information in the server profile information stored in the storage unit 470 for every predetermined period.

Meanwhile, the server profile information may include idle energy-performance information of a corresponding server. In the load balancing apparatus according to the embodiment of the present disclosure, the idle energy-performance information may be used when there exists no information on the resource utilization of a load required to perform a service, a time required to perform the service, etc. because the load profile information of the corresponding load is not stored in the storage unit 470. In an embodiment, the idle energy-performance information may be expressed as an average value of inclinations of power consumption and resource utilization sections of a server in an idle state.

The server monitoring unit 450 monitors current resource utilizations of servers including in the server cluster, a performance state of an assigned load, a power consumption of each server, etc. That is, the server monitoring unit 450 may periodically collect resource utilizations, power consumptions, and current load processing states of the servers in the server cluster, or may collect the information through feedback from each server.

As described above, in the load balancing apparatus according to the embodiment of the present disclosure, the profile management unit 400 manages a profile of a load required to perform a service and a profile of servers included in the server cluster, and provides the profiles the service scheduling unit, so that the service scheduling unit can assign a server suitable for a requested service on the basis of energy-performance information. Accordingly, it is possible to save power consumption of the server cluster and to improve/maintain service quality.

FIG. 5 is a block diagram illustrating an example of a service scheduling unit included in a load balancing apparatus according to an embodiment of the present disclosure.

Referring to FIG. 5, the service scheduling unit 500 includes a service provisioning unit 510, a server selection unit 530, and a job queue 550. The service provisioning unit 510 receives a result obtained by monitoring operational states of servers in a server cluster, which is provided from the profile management unit 400, to create a server list on the basis of a resource available capacity of each server. The server selection unit 530 assigns a server to perform each load on the basis of the load profile information provided from the profile management unit 400 and the server list provided from the service provisioning unit 510. The job queue 550 arbitrarily stores server information assigned for each load by the server selection unit 530.

In an embodiment, the service provisioning unit 510 may create a hash table according to a resource available capacity of each server in the server cluster and allow the created hash table to be included in the server list. In this case, the hash table may use a server ID as a key value, and buckets may be aligned based on energy-performance information of each server.

The server selection unit 530 may select a server having the highest energy-performance value, based on energy-performance information of each server in the hash table created by the service provisioning unit 510. That is, the server selection unit 530 may select a server to perform a service in the hash table on the basis of a resource utilization of a corresponding load, with reference to the load profile information provided from the profile management unit 400 and the hash table created by the service provisioning unit 510. The load scheduled in this manner is disposed in the job queue to wait until the load is assigned to an actual server.

In an embodiment, the profile of the server may include idle energy-performance information of a corresponding server. When a profile of a corresponding load is not stored in the storage unit 470 of the profile management unit 400, the server selection unit 530 may select a server having the highest idle energy-perform value among servers in the idle state. After that, the load profile management unit 410 may create the profile of the load and store the created profile in the storage unit 470.

As described above, in the load balancing apparatus according to the embodiment of the present disclosure, the service scheduling unit 500 assigns a server suitable for a requested service on the basis of energy-performance information when the profile of the load exists, and assigns a server suitable for the requested service on the basis of idle energy-performance information when the profile of the load does not exist. Accordingly, it is possible to save power consumption of the server cluster and to improve/maintain service quality.

FIG. 6 is a flowchart illustrating a load balancing method according to an embodiment of the present disclosure.

Referring to FIG. 6, in the load balancing method according to the embodiment of the present disclosure, a service request is received from a client (S601). The service request is assigned to the load profile management unit 410 (S603), and the load profile management unit 410 determines whether a corresponding load profile exists by searching for the storage unit 470 (S605).

When the load profile exists, a server list is created through service provisioning of the service scheduling unit 500 (S607). That is, the service provisioning may include creating the server list on the basis of operational states and resource utilizations of a plurality of servers included in the server cluster. The server selection unit 530 schedules a corresponding load to a server having the highest energy-performance value (S609). A server to perform the load is specified on the basis of the scheduling result to be assigned to the job queue 550 (S611). Loads assigned to the job queue 550 are sequentially assigned to the server in the server cluster (S613). After the corresponding load is processed by the server, the profile management unit 400 identifies whether a load processing result is to be fed back (S615). Whether the load processing result is to be fed back may be identified by an input from a manger, or may be identified by a predetermined rule. When it is determined that the load processing result is fed back, a monitored load processing result is transmitted from the server monitoring unit 450 to the load profile management unit 410, and the load profile management unit 410 updates load profile information on the basis of the load processing result (S617).

When the load profile does not exist, servers in an idle state within the server cluster are searched by the server monitoring unit 450 (608). The server selection unit 530 schedules the corresponding load to a server having the highest idle energy-performance value among the searched servers in the idle state (S610). A server to perform the load is specified on the basis of the scheduling result to be assigned to the job queue 550 (S612). Loads assigned to the job queue 550 are sequentially assigned to the server in the server cluster (S614). After the corresponding load is processed by the server, the profile management unit 400 identifies whether a load profile of the corresponding load is to be created (S616). Whether the load profile is to be created may be identified by an input from the manager, or may be identified by the predetermined rule. When it is determined that the load profile is generated, a monitored load processing result is transmitted from the server monitoring unit 450 to the load profile management unit 410, and the load profile management unit 410 creates a load profile on the basis of the load processing result (S618). The created load profile is stored in the storage unit 470 of the profile management unit 400, to be used for load balancing in a next service request.

As described above, in the load balancing method according to the embodiment of the present disclosure, a server suitable for a requested service is assigned on the basis of energy-performance information when a load profile exists, and is assigned on the basis of idle energy-performance information when the load profile does not exist. Accordingly, it is possible to save power consumption of the server cluster and to improve/maintain service quality.

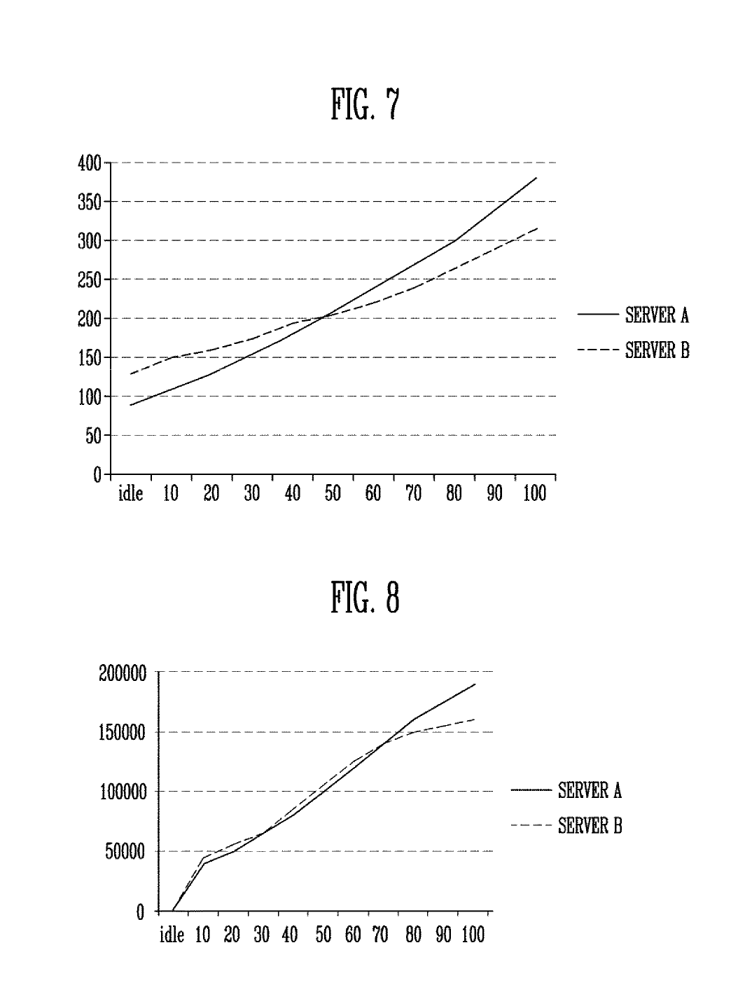

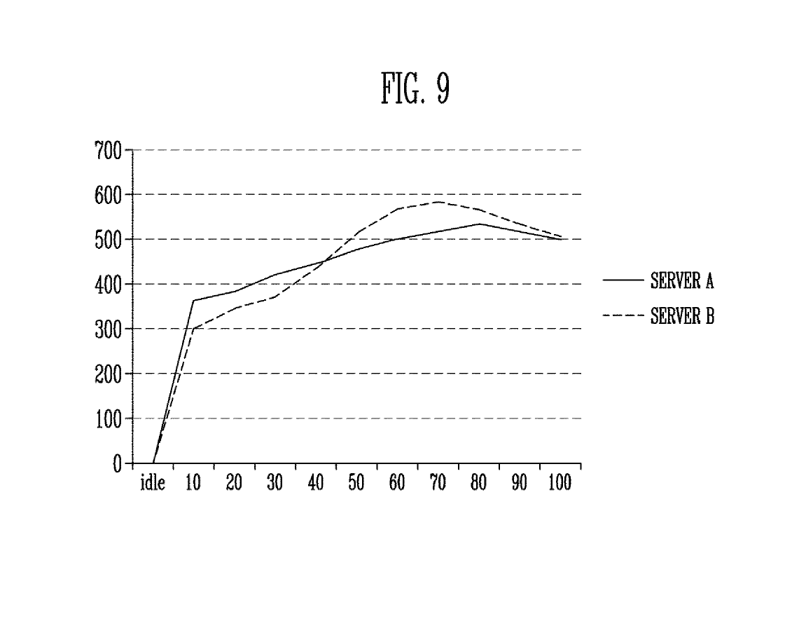

FIG. 7 is a graph illustrating power consumptions required to perform a specific load in two exemplary servers according to their resource utilizations. FIG. 8 is a graph illustrating numbers of transactions performed per unit time in two exemplary servers according to their resource utilizations. FIG. 9 is a graph illustrating energy-performance information in two exemplary servers according to their resource utilizations. Hereinafter, the load balancing apparatus and the load balancing method according to the present disclosure will be described with reference to FIGS. 7 to 9.

Referring to FIG. 7, there is shown a graph illustrating power consumptions required to perform a specific load in servers A and B as exemplary servers according to their resource utilizations. In a section in which the resource utilization is from an idle state to 50%, the power consumption required to perform the specific load in the server A is better than that in the server B. That is, the power consumption of the server A in the idle state is smaller than that of the server B, but an increment of power consumption corresponding to an increase in resource utilization is large in the server A. Hence, if the resource utilization exceeds 50%, the server A consumes more power than the server B.

In FIG. 8, there is shown a graph illustrating numbers of transactions performed per unit time in servers A and B as exemplary servers according to their resource utilizations. The numbers of transactions in the servers A and B are similar to each other until the resource utilization reaches 70%. After that, the number of transactions in the server A is larger than that in server B.

Therefore, when a load is assigned based on power consumption, the load is assigned to the server A in a section in which the resource utilization is low according to the graph of FIG. 7, and is assigned to the server B in a section in which the resource utilization is high according to the graph of FIG. 7. Meanwhile, when a load is assigned based on performance, the server A is preferably assigned in a section in which the resource utilization is 70% or more according to the graph of FIG. 8.

In FIG. 9, there is shown a graph illustrating numbers of transactions per power, which are calculated based on the above-described Equation 1, in servers A and B as exemplary servers according to their resource utilizations. When a load is assigned based on energy consumption, the load is assigned to the server A in a section in which the resource utilization is 50% or less, and is assigned to the server B in a section in which the resource utilization is 50% or more. Thus, the load can be more efficiently assigned in terms of energy. As described above, when a load is assigned, the load is assigned based on energy efficiencies of the load and a server to perform the load, thereby saving energy.

Combinations of respective blocks in the block diagrams and respective operations in the flowchart may be performed by computer program instructions. These computer program instructions can be mounted on a processor of a general-purpose computer, a special purpose computer, or other programmable data processing equipment, and thus the instructions performed by the processor of the computer or other programmable data processing equipment generate a means for performing functions described in the respective blocks of the block diagrams or the respective operations of the flowchart. In order to implement functions in a specific way, these computer program instructions can be stored in a computer-usable or computer-readable memory capable of aiming for a computer or other programmable data processing equipment, so that the instructions stored in the computer-usable or computer-readable memory can also produce a manufactured item including an instruction means for performing functions described in the respective blocks of the block diagrams or the respective operations of the flowchart. Because the computer program instructions can be mounted on a computer or other programmable data processing equipment, a series of operation steps are performed in the computer or other programmable data processing equipment to create a process executed by the computer such that instructions performing the computer or other programmable data processing equipment may provide steps for executing functions described in block(s) of flowcharts.

Further, each block can indicate a part of a module, a segment, or a code including at least one executable instruction for executing specific logical function(s). It should be noticed that several execution examples can generate functions described in blocks out of an order. For example, two continuously shown blocks can be simultaneously performed, and the blocks can be performed in a converse order according to corresponding functions.

As used in this embodiment, the term “˜ unit” refers to software or a hardware structural element such as FPGA or ASIC, and the “˜ unit” perform some roles. However, the “˜ unit” is not limited to software or hardware. The “˜ unit” can be configured to be stored in an addressable storage medium and to play at least one processor. Accordingly, for example, the “˜ unit” includes software structural elements, object-oriented software structural elements, class structural elements, task structural elements, processes, functions, attributes, procedures, subroutines, segments of a program code, drivers, firmware, microcode, circuit, data, database, data structures, tables, arrays, and variables. Functions provided in structural elements and “˜ units” may be engaged by the smaller number of structural elements and “˜ units,” or may be divided by additional structural elements and “˜ units.”

Furthermore, structural elements and “˜ units” may be implemented to play a device or at least one CPU in a security multimedia card.

In the load balancing apparatus and the load balancing method according to the present disclosure, efficiency characteristics of energy and performance of servers are analyzed in terms of power saving that was not considered by the existing load balancing apparatuses, and a load is assigned to an appropriate server in a cluster by analyzing the load to be suitable for service characteristics, so that it is possible to ensure the performance and stability of a system. Accordingly, it is possible to provide a smooth service to users without any quality loss of the service. Further, a service provider can save cost required to operate servers for providing services.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A load balancing apparatus comprising:
a sever cluster configured to include at least one server;
a profile management unit configured to manage a profile of loads required to provide a service and a profile of the server included in the server cluster on the basis of a request from a client; and
a service scheduling unit configured to receive the profile of the loads and the profile of the server, provided from the profile management unit, to determine a server to process the loads,
wherein the profile of the server includes energy-performance information of a corresponding server.

2. The load balancing apparatus of claim 1, wherein the profile management unit includes:
a load profile management unit configured to register, update, and delete the profile of the loads required to provide the service;
a server profile management unit configured to register, update, and delete the profile of the server included in the server cluster;
a server monitoring unit configured to monitor an operational state of the server included in the server cluster; and
a storage unit configured to store data received from the load profile management unit, the server profile management unit, and the server monitoring unit.

3. The load balancing apparatus of claim 2, wherein the data stored in the storage unit includes the profile of the loads, the profile of the server, and a result obtained by monitoring the operational state of the server,
the load profile management unit registers, updates, and deletes the profile of the loads, stored in the storage unit,
the server profile management unit registers, updates, and deletes the profile of the server, stored in the storage unit, and
the server monitoring unit monitors the operational state of the server and stores and updates the monitored result in the storage unit.

4. The load balancing apparatus of claim 2, wherein the service scheduling unit includes:
a service provisioning unit configured to receive the result obtained by monitoring the operation state of the server, provided from the profile management unit, to create a server list on the basis of a resource available capacity of each server;
a server selection unit configured to assign a server to perform each load on the basis of the profile of the loads, provided from the profile management unit, and the server list provided from the service provisioning unit; and
a job queue configured to arbitrarily store information on the server assigned for each load by the server selection unit.

5. The load balancing apparatus of claim 4, wherein the server list is created as a hash table according to a resource utilization of each server.

6. The load balancing apparatus of claim 5, wherein the hash table uses a server ID as a key value, and buckets are aligned based on energy-performance information of each server.

7. The load balancing apparatus of claim 6, wherein the server selection unit selects a server having the highest energy-performance value, based on the energy-performance information of each server in the hash table.

8. The load balancing apparatus of claim 7, wherein the profile of the server includes idle energy-performance information of a corresponding server,
when a profile of a corresponding load does not exist in the storage unit of the profile management unit, the server selection unit selects a server having the highest idle energy-performance value among servers in an idle state, and
the load profile management unit creates the profile of the load and stores the profile of the load in the storage unit.

9. A load balancing apparatus for assigning a load to a server cluster including a plurality of servers, the load balancing apparatus comprising:
a profile management unit configured to manage load profile information required to provide a service and server profile information of the servers included in the server cluster on the basis of a request from a client, wherein the server profile information includes energy-performance information and idle energy-performance information of a corresponding server; and
a service scheduling unit configured to receive the load profile information and the server profile information, provided from the profile management unit, to determine a server to process the loads.

10. The load balancing apparatus of claim 9, wherein the profile management unit includes:
a storage unit configured to store the load profile information and the server profile information;
a load profile management unit configured to manage the load profile information stored in the storage unit;
a server profile management unit configured to manage the server profile information stored in the storage unit; and
a server monitoring unit configured to monitor operational states of the servers included in the server cluster.

11. The load balancing apparatus of claim 10, wherein the service scheduling unit includes:
a service provisioning unit configured to receive a monitoring result of the server monitoring unit and create a server list on the basis of resource available capacities of the servers;
a server selection unit configured to specify a server to perform a corresponding load on the basis of the server list and the load profile information; and
a job queue configured to store a selection result of the server selection unit.

12. A load balancing method for assigning a load to a server cluster including a plurality of servers, the load balancing method comprising:
receiving a service request from a client;
searching a load profile on the basis of the service request;
when the load profile is searched, performing service provisioning on the basis of the searched load profile, wherein the performing of the service provisioning includes creating a server list on the basis of operational states and resource utilizations of the plurality of servers included in the server cluster;
scheduling a corresponding load to a server having the highest energy-performance value on the basis of a result obtained by performing the service provisioning;
assigning an operation schedule to a job queue on the basis of a scheduling result; and
assigning, to the selected server, a load of the operation schedule assigned to the job queue.

13. The load balancing method of claim 12, further comprising, after the assigning of the load to the selected server, updating the load profile.

14. The load balancing method of claim 12, comprising, when the load profile is not searched in the searching the load profile on the basis of the service request,
searching servers in an idle state among the plurality of servers included in the server cluster,
assigning the load to a server having the highest idle energy-performance value among the searched servers, and
creating and storing a load profile of the load.
